(19) United States
(12) Patent Application Publication
(10) Pub. No.: US 2021/0236957 A1
(43) Pub. Date: Aug. 5, 2021

(54) CONDITIONING OF PACKED CHROMATOGRAPHY COLUMNS

(71) Applicant: Biotage AB, Uppsala (SE)

(72) Inventors: Ioannidis PANAGIOTIS, Spanga (SE); Anders WARNGREN, Uppsala (SE); Tobias NORDIN, Uppsala (SE)

(73) Assignee: Biotage AB, Uppsala (SE)

(21) Appl. No.: 17/056,587

(22) PCT Filed: May 21, 2019
(86) PCT No.: PCT/EP2019/063105

§ 371 Date: Nov. 18, 2020

(30) Foreign Application Priority Data
May 24, 2018 (EP) 18174040.8

(51) Int. Cl. B01D 15/16; B01D 15/20; G01N 30/56

(52) U.S. Cl. CPC B01D 15/165; G01N 2030/562; G01N 30/56; B01D 15/203

(57) ABSTRACT

The present invention relates to a method of conditioning a dry-packed chromatography column, which method comprises providing a column packed with inert and hydrophilic chromatography resin; and driving a solvent or solvent mix across the column. The solvent(s) are selected to be less hydrophilic than the chromatography resin; and the rate of the solvent flow is controlled to a rate which does not cause the system pressure to exceed a predefined threshold. The present invention is advantageously used in FLASH chromatography, where the generation of heat may pose problems e.g. to plastic frits or filters at high flow rates and/or wetting of dry resins.

### TECHNICAL FIELD

The present invention relates to the area of chromatography, and more specifically to a method of conditioning a chromatography column. The invention may advantageously be used in FLASH chromatography.

### BACKGROUND

Liquid chromatography is a well-established technique for the separation of one or more target compounds from liquids. The liquid constitutes a mobile phase, which is passed across a stationary phase with which molecules or compounds present in the liquid will interact in different ways. Thus, strong interactions will slow down some molecules or compounds, while weaker interactions will allow a quicker passage, resulting in a differential fractionation of compounds or molecules eluting at different points in time.

In normal phase chromatography, a hydrophilic stationary phase having a stronger affinity for hydrophilic compounds is used together with a less hydrophilic, i.e. less polar mobile phase. If such a mobile phase is driven across a column comprising the stationary phase, e.g. by pumping or by applying positive pressure, the technology is known as FLASH chromatography—a fast and relatively simple method frequently used to separate compounds with different polarities and functional groups.

A commonly used stationary phase in FLASH chromatography is unmodified silica, which is advantageously porous and packed in a column as a dry material. To increase its polarity, the silica is sometimes functionalized with hydrophilic groups, such as silanol groups.

Most separations performed by FLASH chromatography are preceded by a step of conditioning the stationary phase by passage of a mobile phase. Depending on the purpose, the mobile phase used for conditioning may either be the solvent used to elute target compounds during separation, or a different liquid. Conditioning may be performed in order to remove undesired impurities; to regenerate the stationary phase between runs; or simply to wet a dry stationary phase. If desired, conditioning may be performed to establish an appropriate pH by applying a buffer.

In normal phase FLASH chromatography, the stationary phase is commonly supplied in a dry format, and the conditioning thereof will comprise a wetting thereof. In the conditioning of dry silica, a polar solvent will interact with polar groups and displace the air in pores. As the solvent adsorbs to the silica surfaces, heat will be generated due to exothermic reactions. Friction may also build up during the process and generate additional heat.

To overcome the problem of heat generation, silica FLASH cartridges are usually conditioned isocratically prior to sample injection, and the flow rate of the solvent is carefully controlled to avoid excessive heat which could otherwise negatively influence the stationary phase and other parts of the equipment. This sometimes results in a relatively time-consuming conditioning process, requiring several column volumes of solvent before an efficient wetting of the column has been achieved.

Grivel et al. (In J Chromatogr A 2010 Jan. 22; 1217(4):459-72: “Selection of suitable operating conditions to minimize the gradient equilibration time in the separation of drugs by Ultra-High-Pressure Liquid Chromatography with volatile (mass spectrometry-compatible buffers) relates to reversed phase chromatography. More specifically, this article has recognized that problems are associated with long equilibration times in flash chromatography, and presents a study of temperature variation, different flow rates and various additives to the mobile phase used for equilibration. While drawing certain conclusions regarding retention variability and specific equilibration additives, it is also concluded by the authors that the mechanisms which govern equilibration remain very complex and require further work.

WO 2015/140326 (Biotage AB) relates to the equilibration of chromatography columns, and specifically to the heat-related problems that may arise in normal phase FLASH chromatography at increased flow rates. More specifically, according to WO 2015/140326, the heat generated during equilibration of a column packing may be better controlled and the total sample processing may be speeded up by the use of a combination of solvents as a gradient in the equilibration step.

However, despite the solutions proposed above, the conditioning of hydrophilic stationary phases with polar solvents remains a time-consuming step of a purification or isolation process. There is therefore still a need in the area for alternative technologies that deal with problems caused by the exothermic reactions involved when hydrophilic stationary phases are treated with a flow of less hydrophilic solvents.

### SUMMARY OF THE INVENTION

In a first aspect, the present invention relates to a method of conditioning a dry-packed chromatography column, which method comprises
a) providing a column packed with at least one inert and hydrophilic chromatography resin; and
b) driving one or more solvents across the column;
   wherein the solvent(s) is less hydrophilic than the chromatography resin; and
   wherein the rate of the flow of solvent(s) across the column is controlled at a rate which does not cause the column pressure to exceed a predefined threshold.

Other aspects, details and advantages of the invention will appear from the detailed disclosure that follows.

### DEFINITIONS

The term “polar” solvent is used herein for a solvent which has a substantial dipole moment due to the polar bonds formed between atoms with very different electronegativities, such as oxygen and hydrogen.

The term “non-polar” solvent is used herein for a solvent wherein atoms have more similar dipole moments, such as carbon and hydrogen.

The term “hydrophilic” is used herein as a measure of how ‘water loving’ a stationary phase is.

The term “hydrophobic” is used herein as a measure of how ‘water shunning’ a stationary or mobile phase is.

The term “equilibration” is used herein in a broad sense, including bringing two different properties to balance. For example, a dry material which has been fully wetted is considered equilibrated.

### DETAILED DESCRIPTION OF THE INVENTION

The present invention is based on the finding that the heat generation known to arise for example in FLASH chromatography when solvents are passed the resin at high flow rates may be controlled by maintaining the solvent flow rates as high as possible while avoiding exceeding a pressure threshold. In other words, routine testing of a pre-packed chromatography packing may be performed to test at which pressure the heat generation becomes undesired, or intolerable for the equipment used (specifically the frits). Once the pressure threshold is known and defined, chromatography columns of the same dimensions including the same resins may be conditioned by an active regulation of the flow rate as it travels through the column—to maintain the pressure at a predetermined value, the flow rate is sometimes increased and sometimes decreased to drive the conditioning as fast as possible without exceeding the pressure threshold. Thus, the invention uses pressure controlled flow-regulation in column conditioning in order to avoid heat damage such as damage to frit materials.

More specifically, the present invention relates to a method of conditioning a dry-packed chromatography column, which method comprises
a) providing a column packed with at least one inert and hydrophilic chromatography resin; and
b) driving one or more solvents across the column;
   wherein the solvent(s) is less hydrophilic than the chromatography resin; and
   wherein the rate of the flow of solvent(s) across the column is controlled at a rate which does not cause the column pressure to exceed a predefined threshold. As the skilled person will appreciate, two different solvents are commonly used as a mixture e.g. in equilibration of a chromatography column. In the present context, such a mixture is encompassed by the term “solvents” since the mixture will constitute one flow across the column.

Thus, the present inventors have found that instead of the conventional conditioning, where the flow is kept at a rate which does not cause any excessive heating to the equipment, in order to save volumes of solvent, and to save time, such a conditioning may successfully be performed by maintaining the rate of the solvent flow across the column at a rate which does not cause the column pressure to exceed a predefined threshold. The pressure threshold is advantageously set at a level below pressures where heat generation is substantial enough to cause damage to the column or equipment, such as frits or filters. As the skilled person will appreciate, in order to obtain an efficient process, it is desired to maintain the flow at an as high rate as possible.

The pressure threshold may be determined by the skilled person for each specific column and conditions, advantageously by a test run where the released heat is measured for a certain pressure. Illustrative pressure thresholds for flash chromatography columns of sizes 1 g-1500 g are in the range of 1 bar-20 bar.

The purpose of the process, may be to achieve a wetted, equilibrated or otherwise conditioned column. In this context, it is understood that in its broadest sense, the term conditioned may be interpreted as treated with a liquid in order to change or modify one or more properties. In order to judge whether or not a FLASH column has been fully wetted by solvent, its passage across the column including hydrophilic resin may be followed visually, as the front of solvent will appear clearly through a conventional transparent or substantially transparent FLASH column.

As appears from the above, the chromatography resin used according to the invention is hydrophilic rather than hydrophobic. Put differently, the material is may be any suitable material conventionally used in normal phase FLASH chromatography which together with solvents suitable for conditioning and/or elution are exposed to an increased risk of heat generation, for the reasons discussed in the section Background above. The resin may be porous silica, such unmodified silica, in the conventional particle format. Alternatively, the resin comprises alumina, which is another hydrophilic resin. Suitable silica resins may have been functionalized with silanol groups or other polar ligands in order to provide an appropriate level of hydrophilicity for an intended application.

The skilled person will be aware of the kind of solvents that may involve a risk of excessive heat generation when used with hydrophilic resins of the above-discussed kind, especially at certain particle sizes and flow rates. Illustrative such solvents are e.g. methyl acetate, ethyl acetate, acetone, methyl ethyl ketone, methanol, ethanol, 2-propanol, formic acid, acetic acid, triethylamine, and N-ethyldiisopropylamine.

The packed column may be any conventional format suitable for FLASH chromatography. Thus, the column may comprise a specific compartment for addition of sample upstream of the resin; one or more frits or filters arranged downstream and/or upstream of the resin; and/or any other commonly used components. Due to the controlled heat generation obtained with the present invention, the chromatography column may include part or parts made from heat-sensitive material. Thus, at least one frit or filter may be arranged downstream of the resin in the column. Examples of heat-sensitive materials that benefit from the use of the present invention are for example heat-sensitive plastics, such as polyethylene. The present invention may advantageously be used with such filters whereby the risk of softening or melting will be substantially reduced at advantageous high flow rates.

A second aspect of the invention is a method for controlling the flow rate during the conditioning of a packed chromatography column, where a column packed with a hydrophilic resin is conditioned with a less hydrophilic solvent without exceeding a predefined pressure. The method of controlling such conditioning allows for an optimal i.e. as high flow rate as possible, and has been shown by the present inventors to utilize a smaller volume of solvent than conventional conditioning of dry chromatography resins. In an illustrative embodiment, two column volumes (CVs) are sufficient to fully wet a hydrophilic resin with a less hydrophilic solvent. All details above related to the first aspect of the invention are equally applicable to this second aspect.

The method of controlling the heat generation during conditioning of a FLASH chromatography column as described above may be performed by a computer. Thus, the invention also embraces the control of a chromatographic process as discussed above; and software for performing such a method.

A third aspect of the invention is a system for conditioning a dry-packed chromatography column, which system comprises a column packed with at least one inert and hydrophilic chromatography resin; at least one solvent container; means for measuring the pressure within the system; means for passing the solvent at an actively controlled flow rate across the column; and software set to adjust the flow rate of solvent across the column to the maximum value allowed without exceeding a predefined pressure threshold inside the column.

In this context, the term “actively controlled” is understood to mean that the flow rate is varied to values which do not cause the system pressure to exceed a predetermined value. The system will advantageously include the appropriate pump(s), sensor(s) and any additional standard equipment that enables its operation such as tubing.

The system of the invention may include chromatography columns designed to hold about 50-500 g of resin, such as silica, e.g. more than about 50 g, more than about 100 g or more than about 300 g of resin, such as about 350 g or 500 g of resin.

The columns of the system may be plastic, such as polyethylene or polypropylene or any other commonly used plastic material in chromatography columns. Similarly, at least the bottom frit, or both the bottom frit and the top frit located upstream of the resin, may be of the same materials as the column. The present invention is advantageously used with frit materials the heat sensitivity of which makes the unsuitable for conventional conditioning; and/or with frit materials which due to their heat sensitivity are required to be conditioned for extended periods of time and/or using large volumes of solvent unless the pressure controlled flow-regulation of the invention is used.

All details discussed herein in relation to the method are equally applicable to the system, and the other way around.

Thus, the present invention also includes the use of a system according to the invention in a method according to the invention.

### EXPERIMENTAL PART

The present examples are provided herein for illustrative purposes only, and are not to be construed as limiting the present invention as defined by the appended claims. All references provided below or elsewhere in the present application are hereby included via reference.

### Example 1—Equilibration by Variation of the Flow Rate Under Pressure Control (According to the Invention)

A cartridge containing 50 g of 20 μm spherical silica (80 mL column volume) was equilibrated at maximum allowed pressure of 10 bar using in total 160 mL of an isocratic mixture of n-heptane:ethyl acetate in a proportion of 70:30, in which mixture the ethyl acetate is the solvent known to generate heat. The flow rate was controlled in order not to exceed the maximum system pressure, and allowed to reach a maximum of 150 mL/min.

The total equilibration process was performed for 1 minute and 36 seconds. During the equilibration process according to the invention, the pressure was maintained at 10 bar and the flowrate was automatically down-regulated to 20 mL/min at lowest for a few seconds, when the “heat-zone” reached the cartridge's bottom-frit after approximately 80 mL (1 column volume).

The cartridge's surface temperature was continuously monitored and found to be 34° C. at most. After pumping of an additional 80 mL of the isocratic mixture (160 mL in total, 2 column volumes) at 10 bar or 150 mL/min, the cartridge's surface temperature was continuously monitored and found to be 26° C., and the pressure dropped to 6.3 bar at 150 mL/min. The cartridge was carefully inspected visually, and found to be fully equilibrated.

### Example 2—Equilibration at a Fixed Flow Rate (Comparative Example)

The cartridge described above was also subjected to an equilibration method performed at a fixed flow rate using the same solvents as in Example 1, but without the pressure-control of the invention.

In the first method, with 240 mL (3 column volumes) of solvent mixture at 50 mL/min, 7 minutes and 12 seconds was required to complete the equilibration, as judged visually by the solvent from reaching the bottom of the column.

In the second method, 400 mL (5 column volumes) solvent mixture at 100 mL/min takes 6 minutes to complete the equilibration, as judged visually by the solvent from reaching the bottom of the column.

Thus, as appears from the two conventional methods compared above, the duration of an equilibration process may be reduced by using higher flow rates and larger solvent volumes. However, such conventional methods will still entail disadvantages such as larger solvent volumes, which are costly, and an environmental impact.

### Example 3—Equilibration of a 100 g Chromatography Column (According to the Invention)

A cartridge containing 100 g of 20 μm spherical silica (150 mL column volume) was equilibrated at a maximum allowed pressure of 10 bar using a total of 300 mL of an isocratic mixture of n-heptane:ethyl acetate in the proportion 70:30. The flowrate was controlled and allowed to reach a maximum of 100 mL/min.

The total equilibration process was performed in 3 minute. During the new equilibration process according to the invention, the pressure was maintained at 10 bar and the flowrate was automatically down-regulated to 17 mL/min at lowest for a few seconds, when the “heat-zone” reached the cartridge's bottom-frit after approx. 150 mL (1 column volume).

The cartridge's internal temperature was continuously monitored and found to be 116° C. at most. After pumping an additional 150 mL of the isocratic mixture (300 mL in total, 2 column volumes) at 10 bar or 100 mL/min, the cartridge's internal temperature was continuously monitored and was found to be 28° C., and the pressure dropped to 3.1 bar at 150 mL/min. The cartridge was carefully inspected visually, and was found to be fully equilibrated. The cartridge could then be run at a flowrate of 300 mL/min and a pressure of 10.3 bar.

When the same cartridge was run without the pressure regulation of the invention, the cartridge's internal temperature monitored and was found to be 123° C. and the pressure reached >20 bar after approximately 1 column volume (150 mL). The cartridge was blocked and discharged.

Example 4—Equilibration of a 350 g Chromatography Column (According to the Invention)

A cartridge containing 350 g of 20 μm spherical silica (530 mL column volume) was equilibrated at a maximum allowed pressure of 10 bar using in total 1060 mL of an isocratic mixture of dichloromethane:methanol in the proportion 50:50, in which mixture the methanol is the solvent known to generate heat. The flowrate was controlled and allowed to reach a maximum of 200 mL/min.

The total equilibration process was performed for 10 minutes. During the equilibration process of the invention, the pressure was maintained at 10 bar and the flowrate was automatically down-regulated to 49 mL/min at lowest for a few seconds, when the “heat-zone” reached the cartridge's bottom-frit after approximately 530 mL (1 column volume).

The cartridge's surface temperature was continuously monitored and was found to be 53° C. at most. After pumping an additional 530 mL of the isocratic mixture (1060 mL in total, 2 column volumes) at 10 bar or 200 mL/min, the cartridge's internal temperature was continuously monitored and found to be 28° C., and the pressure dropped to 6.0 bar at 200 mL/min. The cartridge was carefully inspected visually, and found to be fully equilibrated.

The cartridge could then be run at a flowrate of 300 mL/min and a pressure of 8.7 bar.

When the same cartridge was run without the pressure regulation, at a fixed flow rate of 200 mL/min, the cartridge's internal temperature was monitored and found to be 59° C. and the pressure reached >20 bar after approximately 1 CV (530 mL).

The cartridge was blocked and discharged.

Thus, the conventionally used conditioning was shown to use more solvent and take longer time than the method according to the present invention.

1. A method of conditioning a dry-packed chromatography column, the method comprising:
providing a column packed with at least one inert and hydrophilic chromatography resin; and
passing one or more solvents across the column;
wherein the one or more solvents are less hydrophilic than the chromatography resin; and
wherein a flow rate of the one or more solvents across the column is controlled at a rate such that a column pressure does not exceed a threshold.

2. A method according to claim 1, wherein the one or more solvents provide an equilibration of the chromatography resin.

3. A method according to claim 1, wherein the passing the one or more solvents includes passing two column volumes of solvent across the column.

4. A method according to claim 1, wherein the resin comprises porous silica.

5. A method according to claim 1, wherein
the packed column comprises at least one filter or frit and
the at least one filter or frit is arranged downstream of the chromatography resin in the column.

6. A method according to claim 5, wherein the at least one filter or frit includes a heat-sensitive material.

7. A method of controlling heat generation in a column, the method comprising:
passing a solvent across the column at a flow rate, such that a column pressure does not exceed a threshold,
wherein the resin is more hydrophilic than the resin.

8. A method according to claim 1, wherein the control is performed by a computer.

9. A system for conditioning a dry-packed chromatography column, the system comprising:
a column packed with at least one inert and hydrophilic chromatography resin;
at least one solvent container;
means for measuring pressure within the system;
means for passing a solvent at an actively controlled flow rate across the column; and
a computer configured to adjust the flow rate of the solvent across the column to the maximum value allowed without exceeding a pressure threshold inside the column.

10. A system according to claim 9, which includes one or more pumps and sensors.

11. A system according to claim 9, wherein the system is configured to control heat-generation during an equilibration of a FLASH chromatography column.

12. A method according to claim 6, wherein the heat-sensitive material is polyethylene.
